(19) United States
(12) Patent Application Publication
(10) Pub. No.: US 2010/0100565 A1
(43) Pub. Date: Apr. 22, 2010

(54) LICENSE MANAGEMENT SYSTEM AND CONTROL METHOD FOR THE LICENSE MANAGEMENT SYSTEM

(75) Inventor: Hiroshi Adachi, Fuchu-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/581,697

(22) Filed: Oct. 19, 2009

(30) Foreign Application Priority Data
Oct. 20, 2008 (JP) 2008-269341

(51) Int. Cl. G06F 21/00; G06F 17/30; H04N 7/16; G06F 7/04

(52) U.S. Cl. 707/781; 726/26; 707/E17.014

(57) ABSTRACT

According to this invention, it is possible to collect device information when a license of software is no longer valid, and process device information collected when the license is no longer valid. According to this invention, it is possible to issue a new license that enables processing of device information collected after a license for software has expired.

### BACKGROUND OF THE INVENTION

1. Field of the Invention

The present invention relates to a license management system which allows a server to issue a license to a client in response to a request to issue a license, and also relates to a control method for the license management system.

2. Description of the Related Art

Conventionally, when a license for software expires, a user cannot execute the software, nor can he process information. In order to prevent this problem from happening, Japanese Patent Application Laid-Open No. 2003-157335 proposes a technique to notify a user of an expiration date of a license when the date is drawing near.

However, if a license of software once expires due to a delay in a license purchasing procedure or a failure in a license issuing system, information after expiration of the license, for example, information about devices, such as an image forming apparatus, cannot be obtained. Thus, the device information becomes missing and the device information cannot be processed because it is unavailable.

### SUMMARY OF THE INVENTION

The present invention is directed to enabling a user to collect device information even after a license for software has expired and to process collected device information even when the license is no longer valid. Furthermore, the present invention is also directed to issuing a new license to enable processing of device information gathered after the license for software has expired.

According to an aspect of the present invention, a license management system includes a client and a server connected via a communication line, in which the client acquires a license for software from the server. The client includes a collecting unit configured to collect device information while the current license of the software is no longer valid, an acquiring unit configured to acquire a new license retroactively moved up to a start date of a valid period thereof the current license of the software is no longer valid, and a permitting unit to permit access to device information collected by the collecting unit, while the current license of the software is no longer valid, on condition that the acquiring unit has acquired a new license.

According to another aspect of the present invention, a license management system has a client and a server connected via a communication line, in which the server issues a license for software to the client. The server includes an issuing unit configured to issue a new license retroactively moved up to a start date of a valid period of the software when a request is received from the client to issue a new license for the software after the current license for the software has expired.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an entire configuration of a license management system according to a first exemplary embodiment of the present invention.

FIG. 2 is a block diagram illustrating a hardware structure of a client or a license server according to the first exemplary embodiment of the present invention.

FIG. 3 is a block diagram illustrating a hardware structure of a device according to the first exemplary embodiment of the present invention.

FIG. 4A is a block diagram illustrating program structure of a control method for a license management system on a client side.

FIG. 4B is a block diagram illustrating program structure of a control method for a license management system on a license server side.

FIG. 4C is a diagram illustrating a difference between a conventional process and a process according to the present invention which retroactively moves up a valid period of a license.

FIG. 5 is a diagram illustrating an example of outline of a process from software purchase until display of device information according to the first exemplary embodiment of the present invention.

FIG. 6 is a management table used in the license server according to the first exemplary embodiment of the present invention.

FIG. 7 is a management table used in the client according to the first exemplary embodiment of the present invention.

FIG. 8 is a flowchart illustrating a procedure for license issuing by a license management system according to the first exemplary embodiment of the present invention.

FIG. 9 is a flowchart illustrating a device information collecting procedure by a license management system according to the first exemplary embodiment of the present invention.

FIG. 10 is a flowchart illustrating a procedure of collection and display of device information by the client in a license management system according to the first exemplary embodiment of the present invention.

FIG. 11 is a management table used by a license server according to a second exemplary embodiment of the present invention.

FIG. 12 is a management table used by the client according to the second exemplary embodiment of the present invention.

FIG. 13 is a flowchart illustrating a license issuing procedure in a license management system according to the second exemplary embodiment of the present invention.

### DESCRIPTION OF THE EMBODIMENTS

Various exemplary embodiments, features, and aspects of the invention will be described in detail below with reference to the drawings.

In a specification of the present application, each license is assigned a license access number, and an individual identifier is used to uniquely identify a client. An example case will be described below, where a license management system of this invention is applied to a system which processes device information by using software which requires issuance of a license.

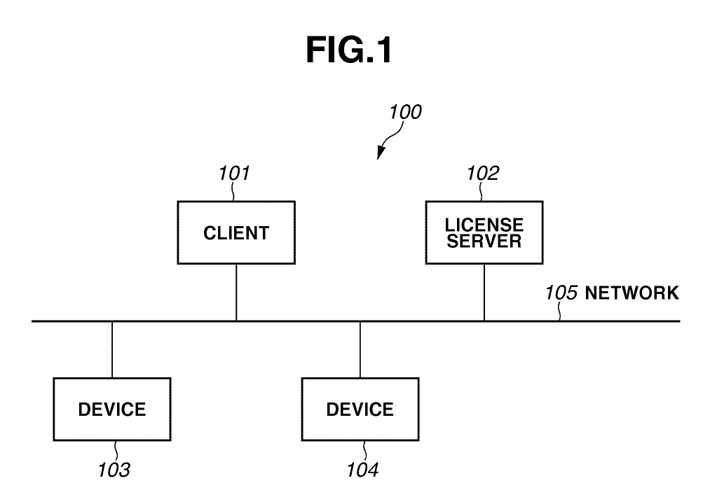

FIG. 1 is a block diagram illustrating an entire configuration of a license management system according to a first exemplary embodiment of the present invention.

A license management system 100 according to a first exemplary embodiment of the present invention includes a client 101 as an information processing apparatus, a license server 102, and devices 103 and 104. In the license management system 100, the client 101, the license server 102, the devices 103, and 104 are mutually connected via a communication line, such as a network 105. In response to request from the client 101 to issue a license for software, the license server 102 issues a license for the software to the client 101. The client acquires a license for the software from the license server 102.

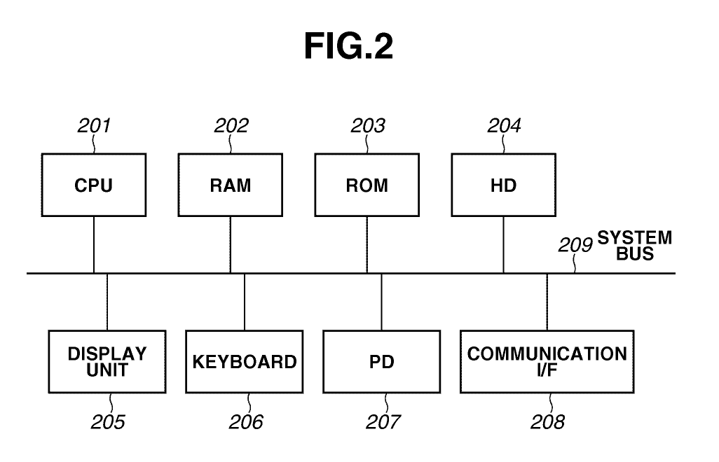

FIG. 2 is a block diagram illustrating a hardware structure of the client 101 and the license server 102. The client 101 and the license server 102 both have a similar hardware structure. Therefore, only the structure of the client 101 is described, and the structure of the license server 102 is not described.

The client 101 includes a central processing unit (CPU) 201, a ready access memory (RAM) 202, a read only memory (ROM) 203, and a hard disk (HD) 204. The client 101 further includes a display unit 205, a keyboard 206, a pointing device (PD) 207, and a communication interface (hereafter referred to as a communication I/F) 208. Those component units 201 to 208 are interconnected to each other via a system bus 209.

Various kinds of computer programs to control the client 101 are stored in the ROM 207 or the HD 204. According to a command from the keyboard 206 or PD 207, the CPU 201 reads a computer program from the ROM 203 or HD 204 and develops the computer program on the RAM 202. The CPU 201 executes the program developed on the RAM 202. The computer program includes a program to manage a license and device information. The computer program also includes a program to enable exchange of information about the license or information about devices 103 and 104 between those devices and the license server 102 via the communication I/F 208.

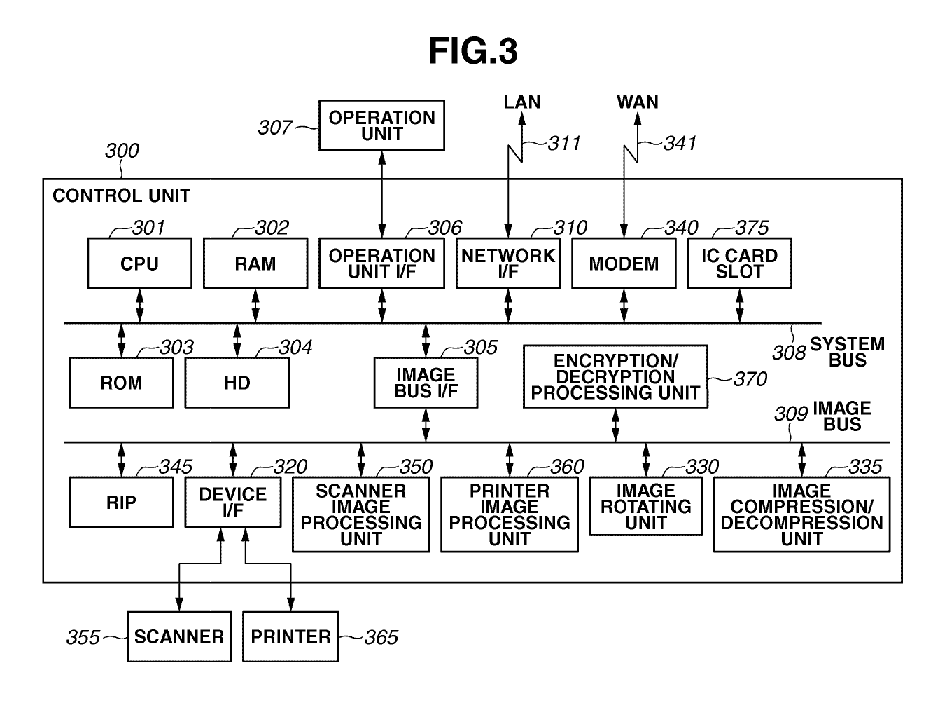

FIG. 3 is a block diagram illustrating the hardware structure of the devices 103 and 104. The devices 103 and 104 each have a control unit 300, an operation unit 307, a scanner 355, and a printer 365. The control unit 300 executes various functions, such as a scanner function, a printer function, a copy function, and a facsimile transmitting/receiving function.

The control unit 300 is connected to a local area network (LAN) 311 and a wide area network (WAN) 341 as well as to the scanner 355 and the printer 365. The control unit 300 receives and processes image data, and outputs processed image data.

The control unit 300 includes a CPU 301, a RAM 302, a ROM 303, a HD 304, an image bus I/F 305, an operation unit I/F 306, a network I/F 310, a device I/F 320, an image rotating unit 330, and an image compression/decompression unit 335. The control unit 300 further includes a modem 340, a raster image processor (RIP) 345, a scanner image processing unit 350, a printer image processing unit 360, a encryption/decryption processing unit 370, and an IC card slot 375.

The control unit 300 includes a system bus 308 and an image bus 309 connected to each other via the image bus I/F 305. The image bus I/F 305 serves as a bus bridge configured to transform a data structure. The image bus 309, which transfers image data at high speed, is formed by a PCI bus or by a bus compliant with IEEE 1394 standard, for example.

The system bus 308 is connected to the CPU 301, the RAM 302, the ROM 303, the HD 304, the operation unit I/F 306, the network I/F 310, the modem 340, and the IC card slot 375.

The CPU 301 controls the entire device by executing a program developed on the RAM 302. In this case, the CPU 301 uses the RAM 302 as a work area and also as an image memory for primary storage of image data. The ROM 303 stores a boot program to develop an operating system (OS) and application software stored in the HD 304 on the RAM 302. The HD 304 also stores image data.

The operation unit I/F 306, which is an interface unit with the operation unit 307 including a touch panel, outputs to the operation unit the image data to be displayed on the operation unit 307. The operation unit 307 also transfers the data input from the operation unit 307, to the CPU 301. The network I/F 310 exchanges data with the LAN 311. The modem 340 exchanges data with the WAN 341. The IC card slot 375 is used to insert an IC card.

The image bus 309 is connected to the raster image processor (RIP) 345, the device I/F 320, the scanner image processing unit 350, the printer image processing unit 360, the image rotating unit 330, the image compression/decompression unit 335, and the encryption/decryption processing unit 370.

The RIP 345 develops code written in page description language (PDL code) into a bit map image. The device I/F 320 connects the scanner 355 and the printer 365 to the control unit 300, and converts between synchronous image data and asynchronous image data. The scanner image processing unit 350 performs various kinds of image processing, such as correction, modification, and editing on input image data. The printer image processing unit 360 performs processing, such as correction and resolution conversion on image data to be printed by the printer 365, according to the printer 365. The image rotating unit 330 rotates image data. The image compression/decompression unit 335 compresses or decompresses multi-valued image data in Joint Photographic Experts Group (JPEG) format, and compresses or decompresses binary image data in Joint B-level Image Experts Group (JBIG), Modified Modified Read (MMR), or Modified Huffman (MH) format. The encryption/decryption processing unit 370 encrypts or decrypts data by using a key provided in an IC card, which is inserted into the IC card slot 375.

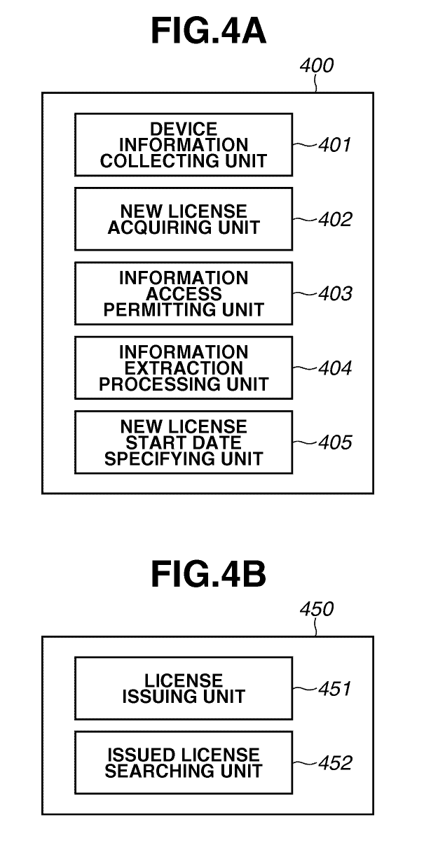

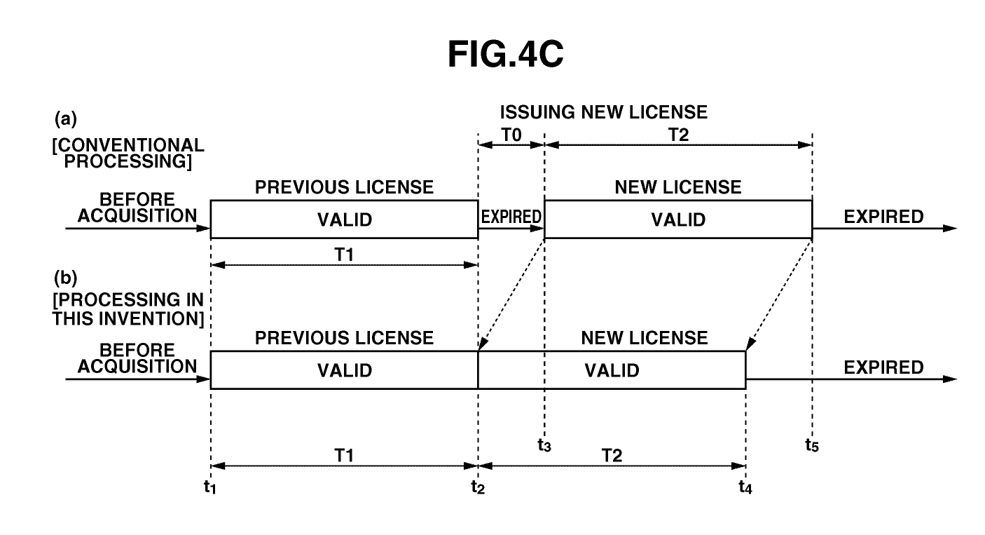

FIG. 4A is a block diagram illustrating a program structure of a control method for a license management system stored in the HD 204 or the ROM 203 of the client. The license management program 400 is a computer program to manage a license or device information. More specifically, the license management program 400 performs license issuing processing by communicating with the license server 102, and collects device information and performs a predetermined processing on the collected device information. The management program 400 includes a collecting unit 401, an acquiring unit 402, a permitting unit 403, a processing unit 404, and a specifying unit 405. By the CPU 201 of the client 101 executing the management control program, the following functions of the collecting unit, the acquiring unit, the permitting unit, the processing unit, and the specifying unit are implemented.

The collecting unit 401 collects device information while the current license for software is no longer valid. The acquiring unit acquires a new license with a retroactively moved up valid period. A start date of the new license is placed directly adjacent to the expired current license of software. More specifically, the acquiring unit 402 acquires the new license, the start date of which is extended backward so that the new license continues from the end date of the valid period of the expired current license.

The permitting unit 403 permits access to device information collected by a function of the collecting unit on condition that a new license has been acquired by a function of the acquiring unit. The processing unit 404 executes predetermined processing to device information, to which the permitting unit 403 permits access. Examples of the predetermined processing are extraction processing of device information, counting processing of device information, and display processing. When the client sends a request to issue a license, the specifying unit 405 of the client specifies a start date of a valid period of a new license.

FIG. 4B is a block diagram illustrating a program structure of a control method for a license management system, stored in the HD 204 or the ROM 203 of the license server 102. A license management program 450 manages issuance of license and issued licenses. The license management program 450 includes a license issuing unit 451 and a license searching unit 452. In the first exemplary embodiment, by the CPU 201 of the license server 102 executing the license management program, the functions of the issuing unit and the searching unit are implemented as described below.

On receiving a request from the client to issue a new license after the current license for software has expired, the issuing unit 451 issues a new license in which a start date of a valid period is retroactively moved up. For the client making a request to issue a new license, the searching unit searches the storage unit of the HD 204 for a license already issued. The storage unit stores, for each client, continuation necessity information indicating whether to continue the already issued license as a new license.

FIG. 4C is a diagram illustrating a difference between processing of the present invention and processing of prior art caused by a retroactively moved-up valid period of a new license. The term “current license” used heretofore is defined as a “previous license” and this defined term will be used in the following description.

As illustrated in (a) in FIG. 4C, conventionally, when the valid period (a valid period from a start date t1 till an end date t2 of the previous license for software) elapses, the previous license expires. As a result, an invalid period of the license appears (a license expired period T0 from a next date of the end date t2 of the valid period T1 till a date before a license acquiring date t3). After a license expires, the software does not collect device information. Subsequently, when the software acquires a new license (when on a license acquiring date t3, a new license of a valid period T2 is acquired which continues from a start date t3 till an end date t5), the software starts collecting device information starting on a date when a new license is issued (on the license acquiring date t3). Therefore, when software counts and displays device information, the license management program cannot process device information for the license expired period T0.

On the other hand, in the present invention (a valid period of software is retroactively moved up), as illustrated in (b) of FIG. 4C, when the valid period (namely, a valid period T1 from the start date t1 till the end date t2 of the license) for software (e.g., management software) elapses, the previous license expires. Consequently, a license expired period appears (namely, a license expired period T0 from a next date of the last date t2 of the previous license till a date before the license acquiring date t3). However, the software continues collecting device information in a background environment even after the previous license has expired.

In order to continue a new license for software from the previous license, if a new license is acquired by specifying a start date of a new license to be a next date of the end date t2 of the valid period T1, the valid period of the new license (start date of a valid period T2) is retroactively moved up. As a result, it now appears as if the license expired period T0 didn't exist. This processing enables the software to access device information which has been collected during the license expired period (T0).

Device information during the license expired period of the license cannot be accessed. When the software counts and displays device information, if a new license with a retroactively moved up valid period is acquired, device information collected during the license expired period can be processed because there is not any expired period of the license.

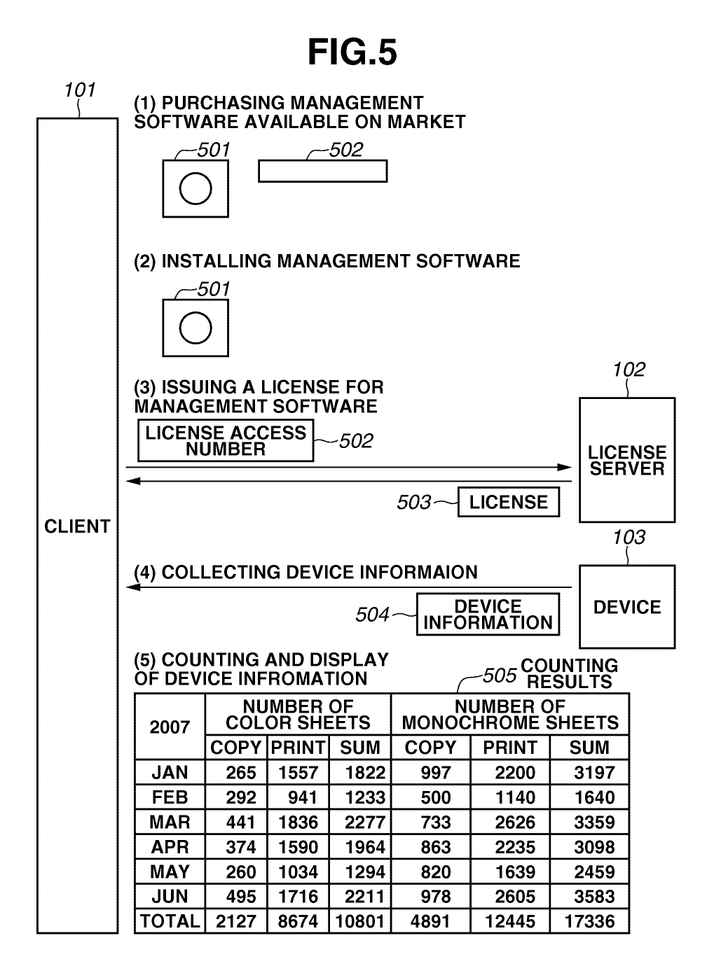

FIG. 5 is a diagram illustrating an example of outline of a process from purchase of management software until display of device information according to the first exemplary embodiment of the present invention.

A user purchases a commercial product of management software. This product includes a recording medium 501, such as a CD-ROM, which stores a program of management software, and a license access number 502 required to install the software.

Then, the user installs the management software. In other words, the user installs the management software in the client by using a storage medium 501. For example, in the client 101, the CPU 201 installs the management software from the recording medium 501 into the RAM 202 or the HD 204.

Then, the license server 102 issues a license for the management software. In the client 101, the user inputs a license access number 502 of the management software. The client 101 sends the license server 102 a request to issue a license 503. The license server 102 generates and sends a license 503 to the client 101. The client 101 receives the license 503.

Subsequently, the client 101 collects device information. When the client 101 acquires the license 503 for the management software, it starts collecting device information 504 in the background environment. The device information includes device usage history (time and day of usage, department name, user name, device name, a number of copied sheets, a number of printed sheets, for example), and also includes device failure history. The client 101 asks the device 103 for device information 504. The device 103 generates and sends device information to the client 101. The client 101 receives device information 504.

The client 101 counts and displays device information. The user at the client 101 inputs a counting method of device information. In compliance with the counting method, the client 101 extracts relevant device information, counts the extracted device information, and displays a counting result 505. The counting result 505 is an example which shows a number of copied sheets and a number of printed sheets in the device 103 from January to June of 2007.

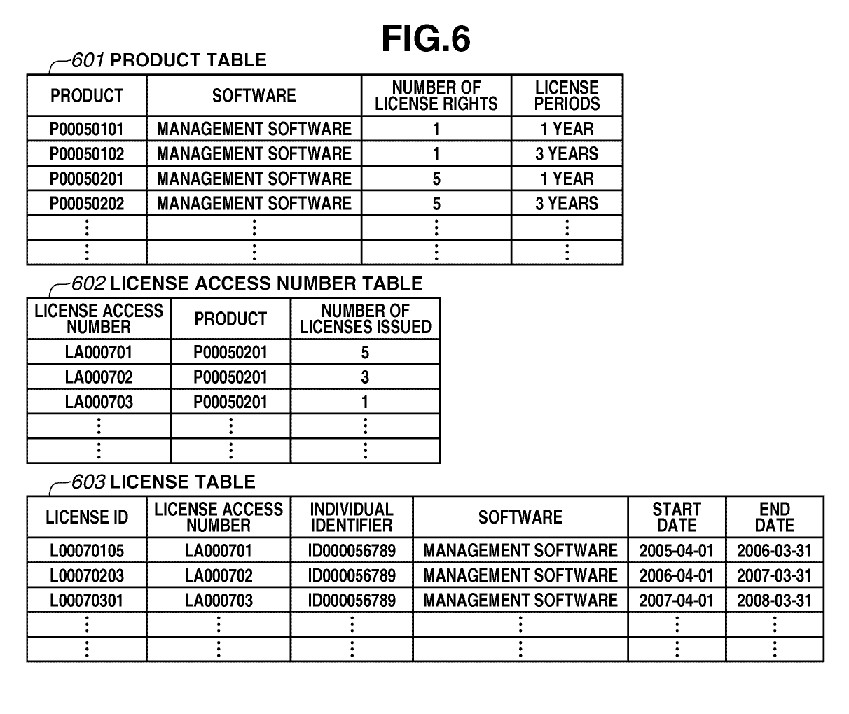

FIG. 6 is a management table used in the license server 102. This management table includes a product table 601, a license access number table 602, and a license table 603. This management table is stored in the RAM 202 or the HD 204.

The product table 601 is used to manage a product composition of software, and holds information, such as product, software, number of license rights, and license period. The license access number table 602 is used to manage correspondence between products and license access numbers, and holds information, such as product, license access number, and number of licenses issued. The license table 603 is used to manage licenses, and holds information, such as license ID, license access number, individual identifier, software, and start date and end date of license.

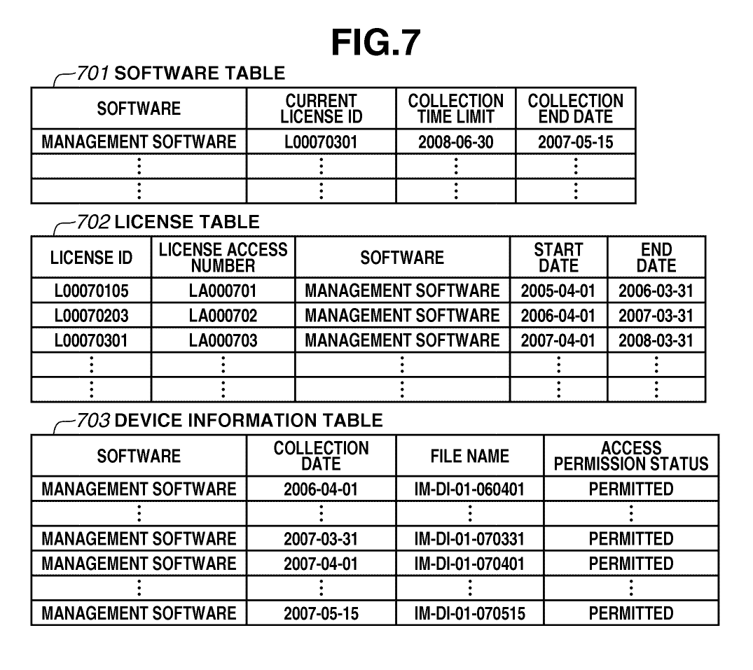

FIG. 7 is a management table used in the client 101. The management table includes a software table 701, a license table 702, and a device information table 703. The management table is stored in the RAM 202 and the HD 204. The software table 701 is used to manage a license status of software, and holds information, such as software, current license ID, information collection deadline, and end date of information collection. The license table 702 is used to manage licenses, and holds information, such as license ID, license access number, software, start date and end date of license. The device information table 703 is used to manage collected device information, and holds information, such as software, collection date, device information file name, and access permission status.

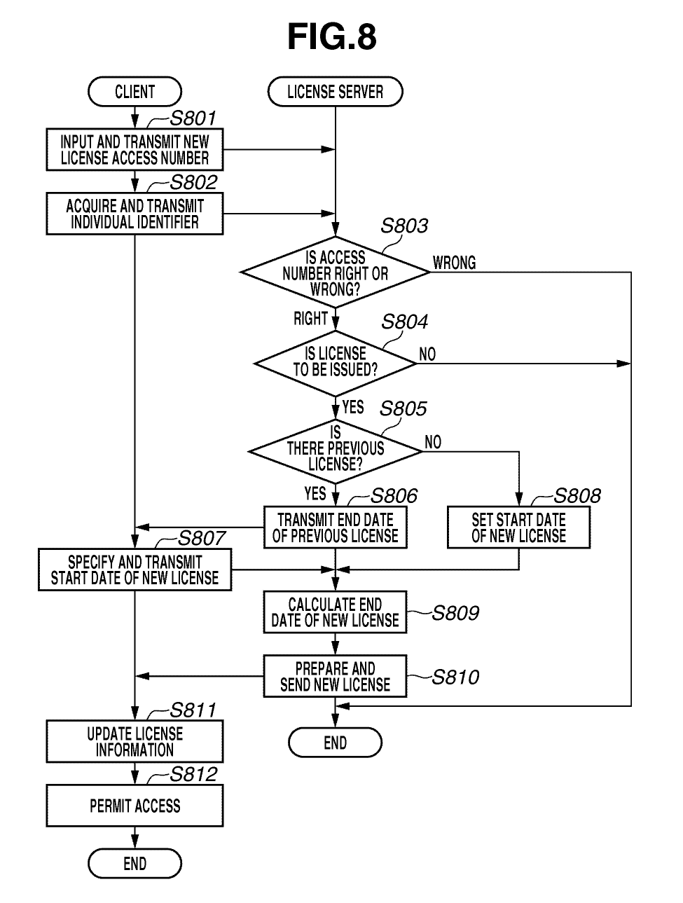

FIG. 8 is a flowchart illustrating a procedure for license issuing processing. The license issuing processing is described with reference to the flowchart. This license issuing processing is performed when the CPU 201 executes programs 400 and 450 having a composition as illustrated in FIGS. 4A and 4B, which are loaded into the HD 204 or the RAM 202.

In step S801, when the user inputs a license access number of a new license into the client 101, the client 101 sends the license access number to the license server 102.

In step S802, the client 101 acquires an individual identifier of its own and sends the identifier to the license server 102. In step S803, the searching unit 452 of the license server 102 checks if the license access number from the client 101 is registered in the license access number table 602, and determines if the license access number is correct. In step S803, if it is determined by the license server 102 that the license access number is registered, the process advances to step S804. On the other hand, if it is determined that the license access number is not registered, the process is terminated.

In step S804, using the product table 601 and the license access number table 602, the searching unit 452 of the license server 102 acquires a number of the issued licenses and a number of license rights based on a license access number. In other words, the searching unit 452 acquires a number of issued licenses based on the above license access number in the license access number table 602. Further, the searching unit 452 acquires a number of license rights based on the same product in the product table 601 as a product which corresponds to the above license access number in the license access number table 602.

Then, the searching unit 452 of the license server 102 determines whether to issue a license by checking if the number of licenses issued<the number of license rights, in which “<” means “is smaller than”. If a relational expression that a number of licenses issued<a number of license rights, holds, the searching unit 452 determines that a license can be issued, and the process proceeds to step S805. On the other hand, if the relational expression does not hold, the searching unit 452 determines that a license should not be issued, and the process is terminated.

In step S805, the searching unit 452 of the license server 102 acquires the relevant software based on a license access number by using the product table 601 and the license access number table 602. In other words, the searching unit 452 searches the license access number table 602 and detects a product corresponding to the above license access number, and also searches the product table 601 and identifies the same product as the product detected above, and acquires software corresponding to the identified product.

The searching unit 452 of the license server 102 searches the license table 603 for a license ID of the software by using a received individual identifier and the acquired software as keys. And, the searching unit 452 acquires information about the previous license corresponding to the license ID, that is, a start date and an end date of the license. If there is a plurality of licenses, the searching unit 452 selects the latest license.

In processing in the license server 102, if there is the previous license found by a search using the individual identifier and software as keys, the process proceeds to step S806. Alternatively, if there is not the previous license, the process moves on to step S808.

In step S806, the searching unit 452 of the license server 102 sends the client 101 an end date of the previous license acquired in step S805.

In step S807, the specifying unit 405 of the client 101 receives an end date of the previous license from the license server 102 sent in step S806, and submits the end date of the previous license. Then, the acquiring unit 403 of the client 101 receives a start date of a new license, and sends the input start date of the new license to the license server 102. After the end of step S807, the process advances to step S809.

In step S808, the issuing unit 451 of the license server 102 sets an execution date of license issuing as the start date of the new license, then the process advances to step S809.

In step S809, the issuing unit 451 of the license server 102 acquires a license period based on a license access number by using the product table 601 and the license access number table 602. In other words, the license server 102 searches the license access number table 602 and detects a product corresponding to the above license access number, and acquires a license period corresponding to the same product in the product table 601 as the product detected in the license access number table 602.

Then, the issuing unit 451 of the license server 102 calculates an end date of a new license from a start date of a new license sent from the client 101 in step S807, or a start date of anew license set in step S808, and the acquired license period. In step S810, the issuing unit 451 of the license server 102 generates a new license (license ID, start date, end date), and sends the new license to the client 101. And, the issuing unit of the license server 102 adds new license information (license ID, license access number, individual identifier, software, start date, end date) to the license table 603. The issuing unit 451 adds 1 to the number of issued licenses corresponding to the license access number in the license access number table 602.

In step S811, the acquiring unit 402 of the client 101 receives a new license (license ID, start date, end date) sent from the license server 102 in step S810. And, the acquiring unit 402 of the client 101 adds the received new license information (license ID, license access number, software, start date, end date) to the license table 702.

The acquiring unit 402 of the client 101 searches the software table to acquire software information (current license ID, collection period, end date of collection) of the new license by using software of the new license as a key.

Then, if there is software information determined by a search made by using software of the new license as a key, the acquiring unit 402 of the client 101 automatically updates the current license ID, license status, and collection deadline in the software table 701. At this point in time, the acquiring unit 402 of the client 101 sets a license ID of the new license to the current license ID and “a date three months after the end date of the new license” in the collection deadline.

On the other hand, if there is not software information determined by a search made by using software of the received new license as a key, the acquiring unit 402 of the client 101 adds software information of the new license to the software table 701. The software information to be added here is that software=“software of a new license”, a current license ID=“a license ID of a new license”, a collection deadline=“a date three months after an end date of anew license”, and an end date of collection=“0000-00-00 (year-month-day)”.

In step S812, the permitting unit 404 of the client 101 checks if “a start date of a new license≦an end date of collection”, and determines whether there is device information to which access is permitted.

If a relational expression of “a start date of a new license≦an end date of collection” holds, the permitting unit 404 of the client 101 extracts device information, for which a collection date exists between a start date and an end date of collection of a new license, in the device information table 703. Device information to be extracted is a file name registered under the heading of file name of the device information table 703. The permitting unit 404 sets “Permitted” to the access permission status corresponding to extracted device information (file name).

On the other hand, if the relational expression of “a start date of a new license≦an end date of collection” does not hold, the client 101 terminates the process.

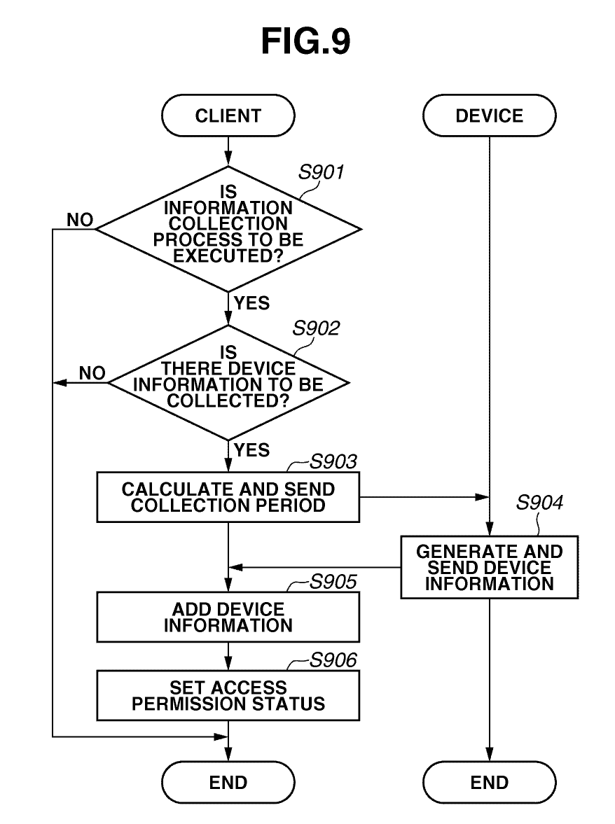

FIG. 9 is a flowchart illustrating a procedure of device information collection processing. The device information collection processing is described with reference to this flowchart.

In step S901, the collecting unit 401 of the client 101 checks if “management software” is registered in the software table 701, and determines whether to execute collection processing of this management software. If it is determined that “management software” is registered, the process of the client 101 proceeds to step S902. On the other hand, if it is determined that “management software” is not registered, this process is terminated.

In step S902, the collecting unit 401 of the client 101 acquires a collection deadline and a collection end date from “management software” by using the software table 701. The collecting unit 401 of the client 101 compares a date before an execution date of collection processing and a collection deadline, determines that whichever comes earlier is an end date of a collection period.

Then, the collecting unit 401 of the client 101 checks if “a collection end date<an end date of a collection period, and determines whether there is device information to be collected. If the relational equation of “a collection end date<an end date of a collection period” holds, processing of the client 101 determines that there is device information to be collected, and the process goes on to step S903. On the other hand, if the relational equation of “a collection end date<an end date of a collection period”, does not hold, it is determined that there is not device information to be collected, and the process terminates the process.

In step S903, the collecting unit 401 of the client 101 calculates a period from a date of a collection end date till an end date of a collection period, and determines this period to be a collection period, and sends this collection period to the device 103 or 104.

In step S904, the device 103 or 104 generates device information within a collection period, and sends the generated device information to the client 101.

In step S905, the collecting unit 401 of the client 101 adds collected device information to the device information table 703. The collecting unit 401 sets an execution date of collection processing to an area, where a collection end date acquired in step S902 is registered, in the software table 701. In other words, a collection end date in the software table 701 is updated from a current collection end date to an execution date of collection processing. Addition of collected device information is done by adding a file name.

In step S906, the client 101 acquires relevant current license ID from “management software” by using the software table 701. By using the license table 702, the client 101 acquires a valid period (a start date and an end date) of the license from the acquired current license ID.

Then, the permitting unit 403 of the client 101 checks the device information table 703 if a collection date of the device information is within a valid period (from a start date until an end date) of the acquired license. As a result, if the collection date is within the valid period, the permitting unit 403 sets “Permitted” to an access permission status corresponding to the device information. On the other hand, if the collection date is not within the valid period, the permitting unit 403 sets “Not permitted” to an access permission status corresponding to the device information.

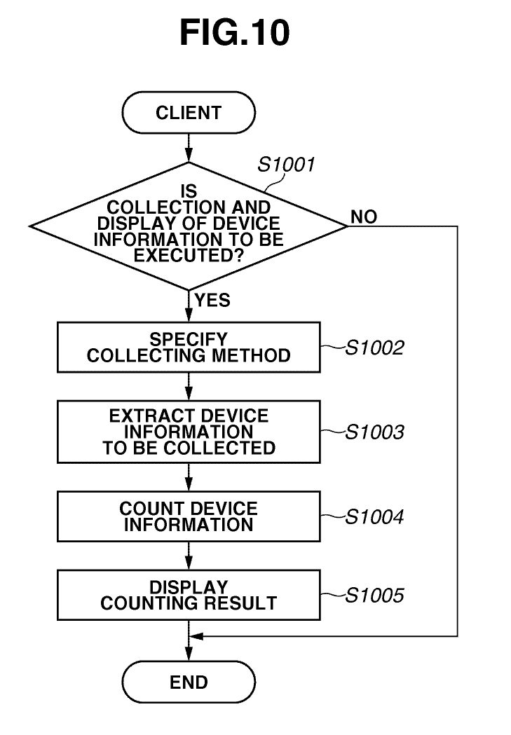

FIG. 10 is a flowchart illustrating a procedure of collection processing and display processing (hereafter referred to as “counting and display processing”) of the device information. The counting and display processing of device information is described with reference to the flowchart.

In step S1001, the processing unit 404 of the client 101 acquires a relevant current license ID based on “management software” by using the software table 701. The processing unit 404 acquires a valid period (a start date and an end date) of a license based on the acquired current license ID by using the license table 702.

The processing unit 404 of the client 101 checks if an execution date of the counting and display processing is within the valid period of the acquired license, and determines whether to execute counting and display processing of management software. If the execution date of the counting and display processing is within the valid period, the processing unit 404 of the client 101 determines that the counting and display processing of the management software is to be executed, and the process advances to step S1002. On the other hand, if the execution date of the counting and display processing is not within the valid period, the processing unit 404 determines that the counting and display processing of the management software is not to be executed, and the process is terminated.

In step S1002, the user inputs a device information counting method (such as a counting period) to the client 101.

In step S1003, from the device information table 703, the client 101 extracts device information in which a collection date is within the counting period input in step S1002 and the access permission status is “Permitted”.

For example, in FIG. 7, it is assumed that the collection period is from Jan. 1 to May 15, 2007, and that the collection date is May 15, 2007. In this case, device information collected in a valid period (Apr. 1, 2006 to Mar. 31, 2007) of the previous license having a license ID=L00070203 in the license table 702 is identified. In addition, device information collected in a valid period (Apr. 1, 2007 to Mar. 31, 2008) of the new license having a license ID=L00070301 is identified. Device information collected in a collection period of Jan. 1 to May 15, 2007 is extracted.

In step S1004, the processing unit 404 of the client 101 counts extracted device information. In step S1005, the processing unit 404 of the client 101 displays a counting result.

In the first exemplary embodiment, when a request is received from the client 101 to issue a new license after the previous license has expired, the license server 102 sends the end date of the expired previous license to the client 101. After this, the start date of the new license specified by the client 101 is set as a start date of a new license. However, this invention is not limited to the above setting, but a start date of a new license may be set as follows.

When a request is received from the client 101 to issue a new license after the previous license has expired, the license server 102 may set a next date of the end date of the valid period of the previous license as a start date of a new license. In this case, because the license server 102 does not send the end date of the valid period of the previous license to the client 101, the client 101 does not specify a start date of a new license.

This can prevent the user from making input errors when specifying a start date of a valid period of a new license so that the valid period of a new license continues from the valid period of the previous license. Therefore, the client 101 securely acquires a new license which has a valid period continuing from the valid period of the previous license. For this reason, it becomes possible to execute predetermined processing of device information collected during an expired period of the license.

As has been described, according to the first exemplary embodiment, the following functions and advantages can be achieved. Even when the license of software is no longer valid, the client 101 can collect device information, and process device information collected while the license is no longer valid.

After the previous license has expired, the client 101 sends a request to issue a new license, and receives from the license server 102 a license with a retroactively moved up valid period which continues from the end date of the expired current license. Therefore, it appears as if the license expired period didn't exist and it is possible to perform posterior predetermined processing on the device information collected during the expired period of the license.

According to a second exemplary embodiment, when the current license is continued, a start date of anew license is not input, but processing to issue anew license to continue from the previous license is added to processing in the first exemplary embodiment.

A license management system, a client, a license server, and a device have structures similar to those illustrated in FIGS. 1, 2 and 3 in the first exemplary embodiment. In the second exemplary embodiment, processing other than license-issuing is similar to those in the first exemplary embodiment. For this reason, in the second exemplary embodiment, only license-issuing processing is described.

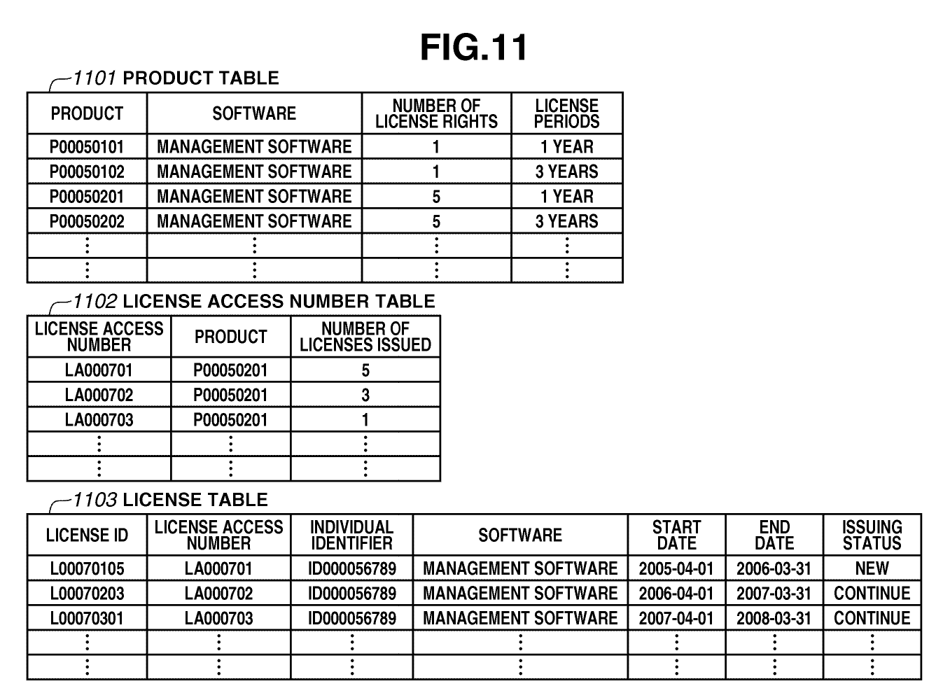

FIG. 11 is a management table used in the license server 102. The management table includes a product table 1101, a license access number table 1102, and a license table 1103. The management table is stored in the RAM 202 or the HD 204.

The product table 1101 is used to manage a product composition of software, and holds information, such as product, software, number of license rights, license period. The license access number table 1102 is used to manage correspondence between products and license access numbers, and holds information, such as product, license access number, and number of licenses issued.

The license table 1103 is used to manage licenses, and holds information, such as license ID, license access number, individual identifier, software, start date and end date of license, and issuance status. The issuance status information includes continuation necessity information indicating whether a license is to be continued.

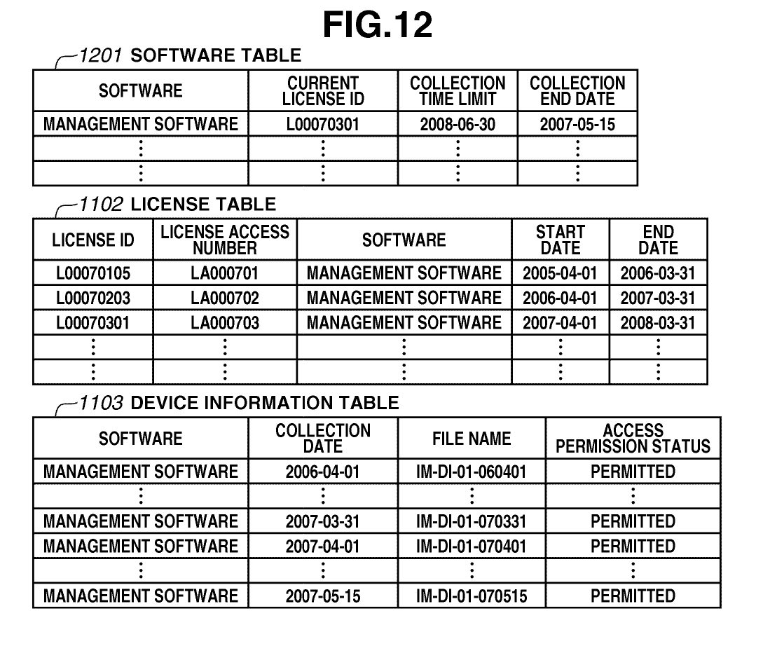

FIG. 12 is a management table used in the client 101. The management table includes a software table 1201, a license table 1202, and a device information table 1203. The management table is stored in the RAM 202 or the HD 204.

The software table 1201 is used to manage license status of software, and holds information, such as software, current license ID, collection deadline, and collection end date. The license table 1202 is used to manage licenses, and holds information, such as license ID, license access number, software, and start date and end date of license. The device information table 1203 is used to manage collected device information, and holds information, such as software, collection date, device information file name, and access permission status.

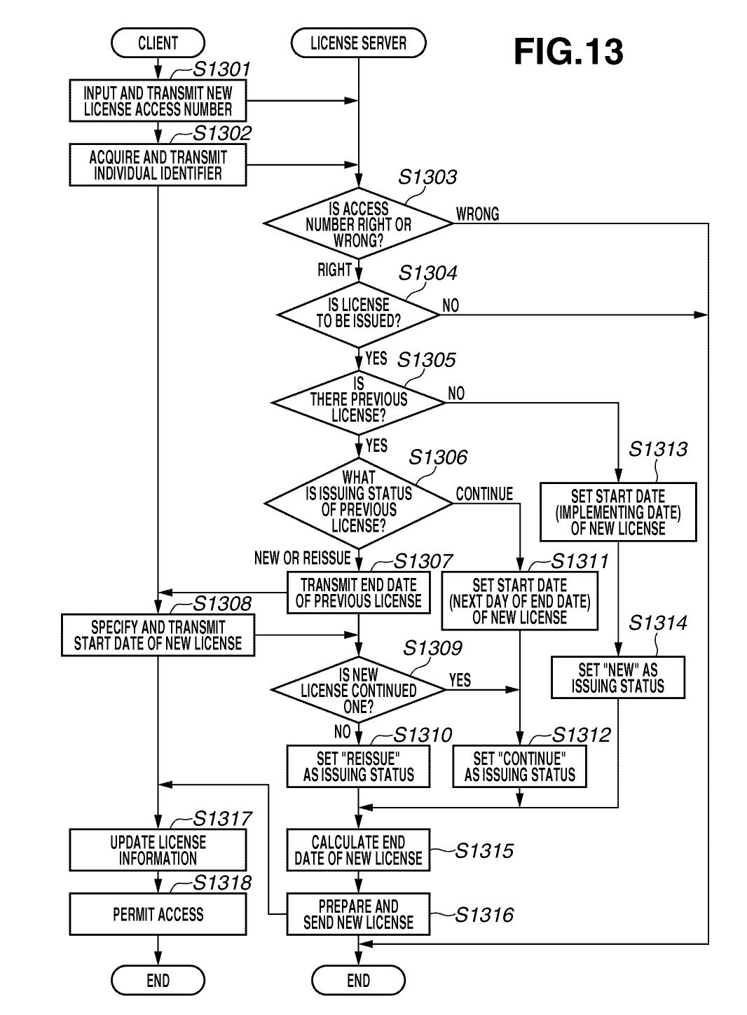

FIG. 13 is a flowchart illustrating a procedure for license issuing. The license issuing processing is described with reference to the flowchart.

In step S1301, a user inputs a license access number of a new license in the client 101. The client 101 sends the license access number to the license server 102.

In step S1302, the client 101 acquires an individual identifier of its own, and sends the identifier to the license server 102.

In step S1303, the searching unit 452 of the license server 102 checks if a license access number from the client 101 is registered in the license access number table 1102, and determines whether the license access number is right. In step S1303, if it is determined in the license server 102 that the license access number is registered, the process advances to step S1304. On the other hand, if it is determined that the license access number is not registered, the process is terminated.

In step S1304, the searching unit 452 of the license server 102 acquires a number of licenses issued and a number of license rights based on a license access number by using the product table 1101 and the license access number table 1102. In other words, the searching unit 452 acquires a number of issued licenses based on the above license access number from the license access number table 1102. The searching unit 452 acquires a number of license rights from the product table 1101 based on the same product as the product which corresponds to the above license access number in the license access number table 1102.

The searching unit 452 of the license server 102 checks if “a number of licenses issued is smaller than a number of license rights”, and determines whether to issue a license. If the relational equation of “a number of licenses issued<a number of license rights”, holds, the searching unit 452 determines that a license is to be issued, and the process advances to step S1305. On the other hand, if the relational equation does not hold, the searching unit 452 determines that a license is not to be issued, and the process is terminated.

In step S1305, the searching unit of the license server 102 acquires relevant software according to a license access number table 1102 by using the product table 1101 and the license access number table 1102. In other words, the searching unit 452 searches the license access number table 1102 and detects a product corresponding to the above license access number. Further, the searching unit 452 identifies a product which is the same as the above detected product, and obtains software corresponding to the identified product.

Then, the searching unit 452 of the license server 102 searches the license table 1103 for a license ID of the previous license by using a received individual identifier and acquired software as keys. As a result, the searching unit 452 acquires information about the previous license (a start date and an end date of the license) corresponding to the above license ID. When there is a plurality of relevant licenses, the searching unit 452 selects a latest license.

In the processing performed by the license server 102, if there is the previous license found by a search using an individual identifier and software as keys, the process advances to step S1306. On the other hand, if there is not the previous license, the process moves on to step S1308.

In step S1306, the searching unit 452 of the license server 102 checks an issuance status of the previous license, and determines whether to issue a new license to continue from the previous license based on continuation necessity information. If the issuance status of the previous license is “Continuing”, the searching unit 452 determines that a new license is to be issued to continue from the previous license, and the process proceeds to step S1311. On the other hand, if the issuance status of the previous license is not “Continuing”, the searching unit 452 determines that a new license is not to be issued to continue from the previous license, and the process advances to step S1307.

In step S1307, the searching unit 452 of the license server 102 sends the end date of the previous license acquired in step S1305 to the client 101

In step S1308, the specifying unit 405 of the client 101 submits the received end date of the previous license sent from the license server 102 in step S1307. The specifying unit 405 receives a start date of a new license, and sends the input start date to the license server 102. After step S1308 is finished, the process moves on to step S1309.

In step S1309, the issuing unit 451 of the license server 102 checks if “a start date of a new license=next date of the end date of the previous license”, and determine whether a new license is to continue from the previous license. If a relational equation of “a start date of a new license=next date of the end of the previous license” holds, the license server 102 determines that a new license is to continue from the previous license and the process proceeds to step S1312. On the other hand, if the above relational equation does not holds, the license server determines that a new license is not to continue from the previous license, and the process advances to step S1310.

In step S1310, the issuing unit 451 of the license server sets “Reissue” to the issuance status of a new license, and then the process advances to step S1315. In step S1311, the issuing unit of the license server 102 sets a next date of the end date of the previous license as a start date of a new license, and then the process advances to step S1312.

In step S1312, the issuing unit 451 of the license server 102 sets “Continuing” to the issuance status of a new license, and then the process proceeds to step S1315. In step S1313, the issuing unit 451 of the license server 102 sets an execution date of license issuing processing as a start date of a new license, and then the process proceeds to step S1314.

In step S1314, the issuing unit 451 of the license server 102 sets “New” to the issuance status of a new license, and then the process goes on to step S1315. In step S1315, the issuing unit 451 of the license server 102 acquires a license period corresponding to a license access number by using the product table 1101 and the license access number table 1102. In other words, the issuing unit 451 searches the license access number table 1102 and detects a product corresponding to the license access number, and acquires a license period corresponding to the same product in the product table 1101 as the above detected product from the license access number table 1102.

The issuing unit 451 of the license server 102 calculates an end date of a new license based on a start date of a new license acquired in steps S1308, S1311, and S1313, and an acquired license period.

In step S1306, the issuing unit 451 of the license server 102 generates and sends a new license (a license ID, a start date, and an end date) to the client 101. The issuing unit 451 adds information about a new license (a license ID, license access number, individual identifier, software, a start date, an end date) to the license table 1103. The issuing unit 451 adds 1 to the relevant number of licenses issued in the license access number table 1102.

In step S1317, the acquiring unit 402 of the client 402 receives a new license (a license ID, a start date, and an end date) sent from the license serve 102 in step S1316. The acquiring unit 402 adds received information about a new license (a license ID, a license access number, software, a start date, and an end date) to the license table 1202.

The acquiring unit 402 of the client 101 searches for software information about a new license (a current license ID, a collection period, a collection end date) using software of the received new license as a key in the software table 1201.

If there is software information in the software table 1201, the acquiring unit 402 of the client 101 automatically updates the current license ID, license status, and collection deadline corresponding to the new license. For example, the client 101 sets a license ID of the new license to the license ID, and “a date three months after the end date of a new license” to the collection deadline.

On the other hand, if there is not software information in the software table 1201, the client 101 adds software information about the new license to the software table 1201. For example, software information to be added includes software=“software of the new license”, the current license ID=“license ID of the new license”, the collection deadline=“date three months after the end date of the new license”, and the collection end date=“0000-00-00”.

In step S1318, the permitting unit 403 of the client 101 checks if “start date of the new license≦the collection end date” and determines whether there is device information to which access is permitted.

If the relational equation of “start date of the new license≦the collection end date” holds, the permitting unit 403 of the client 101 extracts device information in which the collection date is from the start date until the collection end date of the new license from the device information table 1203. An example of device information is a file name registered under the heading of file name in the device information table 703. The permitting unit 403 sets “Permitted” to the access permission status corresponding to extracted device information (file name). On the other hand, if the relational equation of “start date of the new license≦the collection end date” does not hold, the process is terminated.

As has been described, according to the second exemplary embodiment, in addition to the above-mentioned functions and the advantages in the first exemplary embodiment, the following advantage is achieved. When the current license is continued, a new license is issued based on continuation necessity information registered previously, and a start date of the new license need not be input. This enables the client to securely acquire a new license with a valid period continuing from the previous license. Therefore, a predetermined processing of device information collected during an expired period of the license can be executed most surely.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application No. 2008-269341 filed Oct. 20, 2008, which is hereby incorporated by reference herein in its entirety.

What is claimed is:

1. A license management system having a client and a server connected via a communication line, in which the client acquires a license for software from the server, wherein the client includes:
a collecting unit configured to collect device information while the current license of the software is no longer valid;
an acquiring unit configured to acquire a new license in which a start date of a valid period of the software is retroactively moved up while the current license of the software is no longer valid; and
a permitting unit to permit access to device information collected by the collecting unit, while the current license of the software is no longer valid, on condition that the acquiring unit has acquired a new license.

2. The license management system according to claim 1, wherein the acquiring unit acquires a new license in which the start date of the valid period is retroactively moved up so that the new license continues from the end date of the valid period of the expired current license.

3. The license management system according to claim 1, wherein the client further includes a processing unit to execute processing on device information to which the permitting unit permits access.

4. The license management system according to claim 3, wherein the processing unit counts or displays device information collected by the collecting unit while the current license of the software is no longer valid.

5. A license management system having a client and a server connected via a communication line, in which the server issues a license for software to the client, wherein the server includes:
an issuing unit configured to issue a new license in which a start date of a valid period of the software is retroactively moved up, when a request is received from the client to issue a new license for the software after the current license for the software has expired.

6. The license management system according to claim 5, wherein the client includes a specifying unit to specify a start date of the valid period when sending a request to issue a new license, and wherein the issuing unit of the server issues a new license in which a start date of a valid period is retroactively moved up so that the specified start date is to be the start date of the valid period if the start date of the valid period is retroactively specified by the specifying unit of the client.

7. The license management system according to claim 5, wherein the issuing unit issues a new license in which the start date of the valid period is retroactively moved up so that the new license continues from the end date of the expired current license.

8. The license management system according to claim 5, wherein, the server further includes, for each client,
a storage unit configured to store an issued license and information about whether the license is to be continued;
a searching unit configured to search the storage unit for a license already issued to the client who has submitted a request to issue a new license,
wherein the issuing unit automatically issues a new license when the continuation necessity information about the license searched by the searching unit indicates that the license is to be continued.

9. A control method for controlling the license management system having a client and a server connected via a communication line, in which the client acquires a license for software from the server, the control method comprising:
collecting device information while the current license of the software is no longer valid;
acquiring anew license in which a start date of a valid period of the software is retroactively moved up while the current license of the software is no longer valid; and
permitting access to device information collected by the collecting unit, while the current license of the software is no longer valid, on condition that the acquiring unit has acquired a new license.

10. The control method for controlling the license management system having a client and a server connected via a communication line in which the server issues a license for software to the client, wherein server includes:
issuing a new license of the software, in which a start date of a valid period of the software license is retroactively moved up, when a request is received from the client to issue a new license for the software after the current license for the software has expired.

11. A computer-readable recording medium that stores a program to execute the control method for the license management system described in claim 9.

12. A computer-readable recording medium that stores a program to execute the control method for the license management system described in claim 10.
